(19) United States
(12) Patent Application Publication
(10) Pub. No.: US 2012/0106174 A1
(43) Pub. Date: May 3, 2012

(54) LAMP WITH DOUBLE WATER RESISTANCE STRUCTURE

(75) Inventors: Shih-Jen Chuang, Sindien City (TW); Yin-Hsien Li, Sindien City (TW); Sheng-Hung Huang, Sindien City (TW)

(73) Assignee: ECOLIGHTING, INC CORP.

(21) Appl. No.: 12/915,221

(22) Filed: Oct. 29, 2010

(51) Int. Cl. F21V 31/00

(52) U.S. Cl. 362/375

(57) ABSTRACT

The lamp includes a lamp hood, a lighting set and a power connector. The lamp hood has a divider plate for dividing inside thereof into an upper chamber and a lower chamber. The lighting set is disposed in the upper chamber. A cover is mounted on the opening of the upper chamber. The power connector is disposed in the lower chamber and provided with fastening members for connecting to the lamp hood. The power connector has an annular wall penetrating the lower chamber. The annular wall tightly clings against the inner wall of the lower chamber. A first sealing ring and a second sealing ring are sandwiched between the lamp hood and cover and between the lamp hood and annular wall, respectively.

### BACKGROUND OF THE INVENTION

1. Technical Field

The invention relates to lamps, particularly to cup lamps for outdoor use.

2. Related Art

The lamps for outdoor use must be provided with a water resistance structure. Conventional water resistance structures usually employ screw assembling approach which requires busy manual operation. Some of them employ glue bonding approach, it still tends to be damaged because of getting old.

### SUMMARY OF THE INVENTION

An object of the invention is to provide a lamp with double water resistance structure, which can improve water repellency and durability.

To accomplish the above object, the lamp of the invention includes a lamp hood, a lighting set and a power connector. The lamp hood has a divider plate for dividing inside thereof into an upper chamber and a lower chamber. The lighting set is disposed in the upper chamber. A cover is mounted on the opening of the upper chamber. The power connector is disposed in the lower chamber and provided with fastening members for connecting to the lamp hood. The power connector has an annular wall penetrating into the lower chamber. The annular wall tightly clings against the inner wall of the lower chamber. A first sealing ring and a second sealing ring are sandwiched between the lamp hood and cover and between the lamp hood and annular wall, respectively.

### BRIEF DESCRIPTION OF THE DRAWINGS

FIG. 1 is an exploded perspective view of the invention;

FIG. 2 is an assembled perspective view of the invention;

FIG. 3 is a cross-sectional view of the invention

FIG. 4 is a partially enlarged view of part A in FIG. 3;

FIG. 5 is a partially enlarged view of another embodiment of part A in FIG. 3; and

FIG. 6 is a partially enlarged view of still another embodiment of part A in FIG. 3.

### DETAILED DESCRIPTION OF THE INVENTION

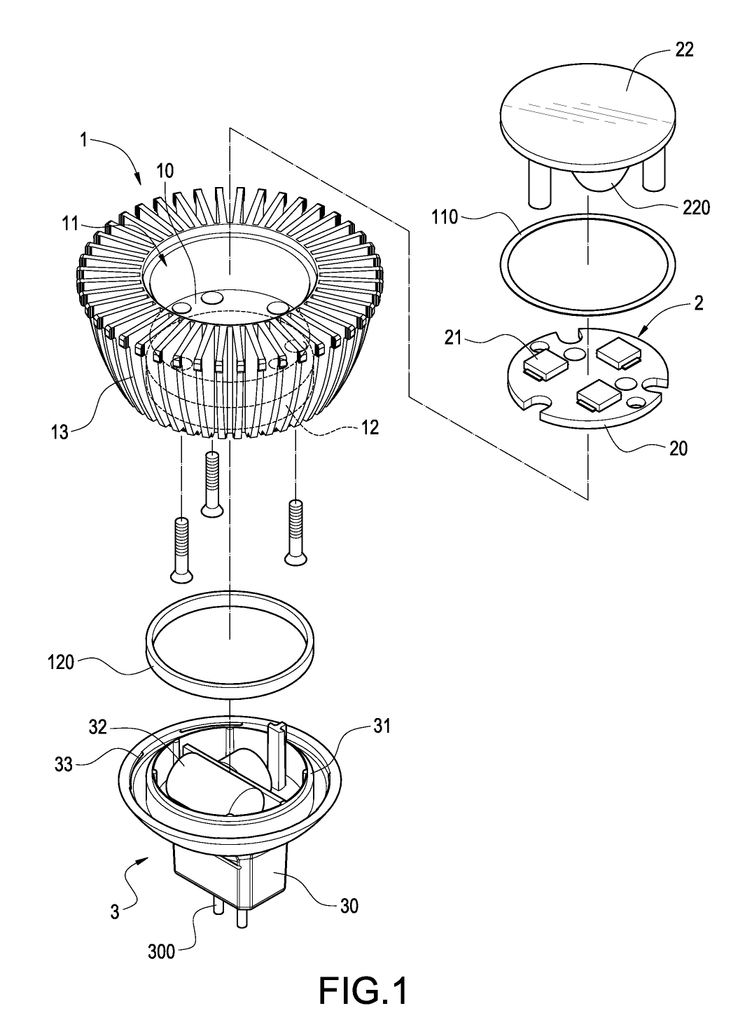

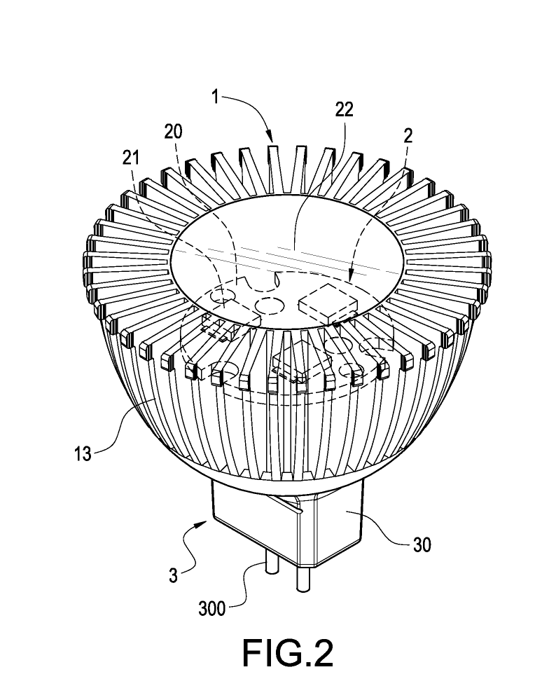

Please refer to FIGS. 1-3, which are an exploded perspective view, assembled perspective view and a cross-sectional view of the invention. The lamp of the invention includes a lamp hood 1, a lighting set 2 and a power connector 3.

The lamp hood 1 is made of a metallic material with great thermal conductivity, such as aluminum. The lamp hood 1 is of a cup shape and is provided with a divider plate 10. The divider plate 10 divides the inside of the lamp hood 1 into a first chamber 11 and a second chamber 12. Additionally, a plurality of fins 13 extend from the outside of the lamp hood 1.

The lighting set 2 is accommodated in the upper chamber 11 and includes a circuit board 20, at least one lighting unit 21 on the circuit board 20 and a transparent or translucent cover 22 through which the lights from the lighting set penetrate. The lighting unit 21 may be a light emitting diode (LED). Preferably, a lens 220 may be formed on the inside of the cover 22 for focusing the lights from the lighting unit 21. The back side of the circuit board 20 clings to the divider plate 10 for heat transfer from the lighting unit 21 to the fins 13 via the divider plate 10.

The power connector 3 is mounted on the lower chamber 12. There is a plug 30 on the power connector 3. Two pins 300 are disposed on the plug 30 for connecting electric power. The power connector 3 is further provided with an annular wall 31 penetrating into the lower chamber 12. A control module 32 or any other electric module may be accommodated in the annular wall 31. The power connector 3 may be further provided with a plurality of fastening members 33 for removably connecting to the lamp hood 1.

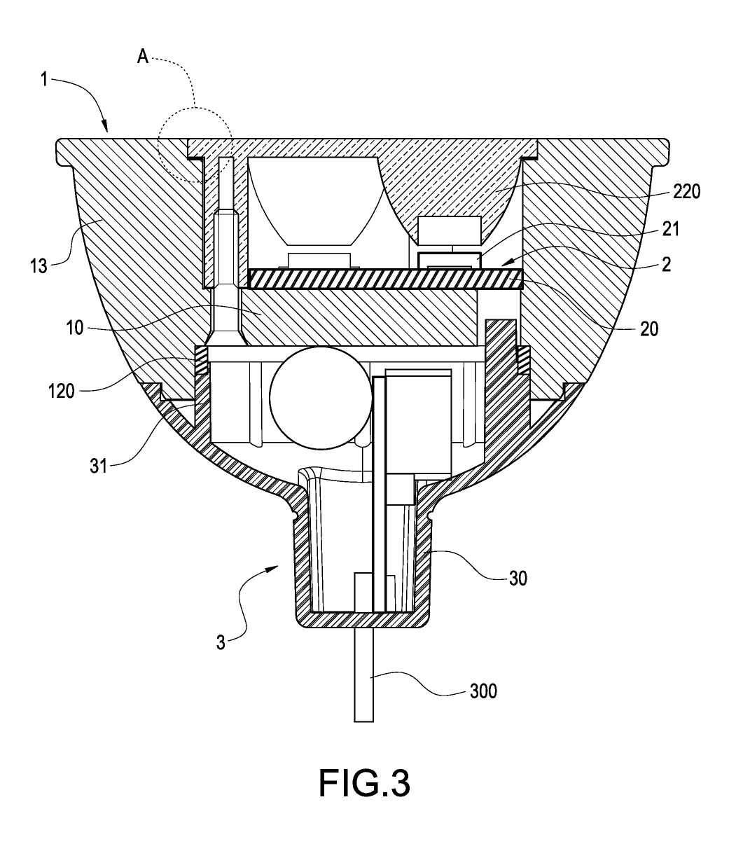

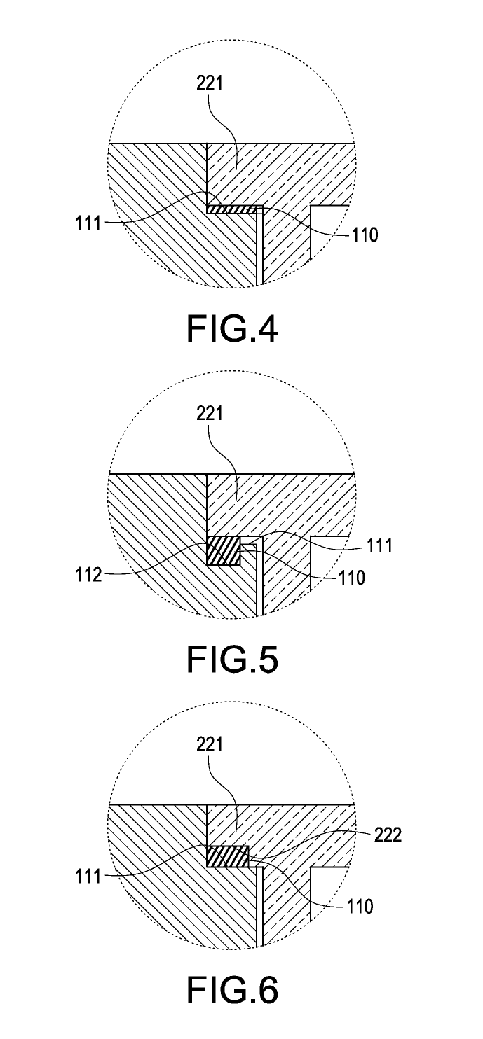

A first sealing ring 110 is sandwiched between the lamp hood 1 and the cover 22 for serving as the first water resistance mechanism. A second sealing ring 120 is sandwiched between the lamp hood 1 and the annular wall 31 for serving as the second water resistance mechanism. As can be seen in FIG. 3, the annular wall 31 penetrates into the lower chamber 12 to cling against the inner wall of the lower chamber 12 for forming a close fit and making the second sealing ring 120 put between the annular wall 31 and lower chamber 12. In the embodiment shown in FIG. 4, an annular recess 111 is formed on an opening of the upper chamber 11 of the lamp hood 1 and a flange 221 corresponding to the annular recess 111 is formed on a periphery of the cover 22. The first sealing ring 110 is just sandwiched between the annular recess 111 and the flange 221.

FIG. 5 shows another embodiment of the invention. In this embodiment, the annular recess 111 further forms an annular slot 112 for accommodating the first sealing ring 110. And the first sealing ring 110 is still sandwiched between the annular recess 111 and the flange 221.

FIG. 6 shows still another embodiment of the invention. In this embodiment, an annular trough 222 is formed on the flange 221 for accommodating the first sealing ring 110. And the first sealing ring 110 is still sandwiched between the annular recess 111 and the flange 221.

Therefore, the lamp of the invention can reduce manufacturing costs and simplify the manufacturing process because no screw and glue is needed. The double sealing ring can guarantee the water repellency and durability.

Those skilled in the art will appreciate that numerous changes and modifications can be made to the preferred embodiments of the invention, and that such changes and modifications can be made without departing from the spirit of the invention.

What is claimed is:

1. A lamp comprising:
a lamp hood having a divider plate for dividing an inside thereof into an upper chamber and a second chamber;
a lighting set, disposed in the upper chamber, and having a cover disposed on an opening of the upper chamber; and
a power connector, disposed in the lower chamber, having fastening members for connecting to the lamp hood and an annular wall penetrating into the lower chamber, and the annular wall clinging against an inner wall of the lower chamber;
wherein a first sealing ring is sandwiched between the lamp hood and the cover, and a second sealing ring is sandwiched between the lamp hood and the annular wall.

2. The lamp of claim 1, wherein the lamp hood is of a cup shape and provided with fins extending outwards.

3. The lamp of claim 1, wherein an annular recess is formed on an opening of the upper chamber and a flange is formed on a periphery of the cover, so that the first sealing ring is sandwiched between the annular recess and the flange.

4. The lamp of claim 3, wherein the annular recess further forms an annular slot for accommodating the first sealing ring.

5. The lamp of claim 3, wherein an annular trough is formed on the flange for accommodating the first sealing ring.

6. The lamp of claim 1, wherein the lighting set further comprises a circuit board and at least one lighting unit on the circuit board, and the cover is transparent or translucent through which lights from the lighting set penetrate.

7. The lamp of claim 1, wherein the lighting set further comprises at least one lighting unit, and a lens is formed on the cover and the lens faces the lighting unit.

8. The lamp of claim 6, wherein the at least one lighting unit is a light emitting diode.
